(19) United States
(12) Patent Application Publication
(10) Pub. No.: US 2009/0188018 A1
(43) Pub. Date: Jul. 30, 2009

(54) Hygienic mitt and method of manufacture

(76) Inventors: Andrea Elizabeth Bates, Atlanta, GA (US); Lance Donald Reich, Smyrna, GA (US); E. Michelle Tyde, Atlanta, GA (US)

Correspondence Address: Andrea E. Bates, 526 Hardendorf Avenue, Atlanta, GA, 30307-1716, US

(21) Appl. No.: 12/011,592

(22) Filed: Jan. 28, 2008

(51) Int. Cl. A41D 19/01; B23P 11/00

(52) U.S. Cl. 2/158; 29/428

(57) ABSTRACT

A disposable hygienic mitt that is selectively detachable from other mitts, preferably held in a dispensable roll or stack. The mitt has a rectangular body formed of at least an outer absorbent layer and an inner substantially liquid-repellant layer, and has a thumb portion thereof that is integral with the body and selectively individually articulable therefrom with a thumb passage therein. The inner layer forming a substantially liquid-tight interior of the mitt such that a hand selectively fits within the interior and the thumb of the hand fits within the thumb passage. The thumb portion preferably articulates from the body from the thumb being inserted into the thumb passage.

### BACKGROUND OF THE INVENTION

1. Field of the Invention

The present invention generally relates to hygienic paper and gloves. More particularly, the present invention relates to a disposable hygienic mitt for sanitary use.

2. Description of the Related Art

It is common for a person to use toilet or tissue paper to remove fecal matter from the anal region after defecation, often called “wiping” one's backside. One problem that occurs in using tissue paper for wiping is that one has to hold the tissue paper in the fingers while wiping and this can cause the fingers to get fecal matter onto them. To mitigate against this problem, one often wraps a series of toilet sheets around the hand itself so that the tissue paper does not need to be gripped. However, this uses a significant amount of tissue paper for one wiping, which is both wasteful of the tissue and can clog the plumbing of the toilet from the attempting flushing of the large amount of waste tissue.

Another problem arises in the toilet training of small children in the use of toilet paper. Children are notorious for both using a large volume of tissue paper to attempt wiping and then clogging a toilet with the tissue, and also for not effectively wiping and getting fecal matter on their hands and other parts of the body.

There have been several hygienic gloves, mitts and variants thereof put forth as a solution to the above problems. All of these however are typically specially manufactured as a glove or mitt, which increases the per unit cost of manufacture for each and also requires a separate dispensation method, as opposed to the simple “roll” of toilet paper stored adjacent the toilet. Some have provided a simple mitt, basically akin to a bag into which a person places their hand and then commences to wipe. However, a simple bag shape is prone to slip off the hand and is difficult to fit within the buttocks to adequately clean the anal region without the dexterity of the fingers and thumb.

Accordingly, it is desirous to provide a disposable alternative to tissue paper that minimizes the risk of fecal matter-to-skin contact when wiping the anal region. Furthermore, such alternative should be simple in design and inexpensive to manufacture to provide a viable alternative to toilet paper, or an aid in its use. The present invention is therefore directed to such an alternative.

### SUMMARY OF THE INVENTION

Briefly described, the present invention is disposable hygienic mitt that can be formed as selectively detachable from other mitts held in a dispensable roll. The mitt has a rectangular body formed of at least an outer absorbent layer and an inner substantially liquid-repellant layer, and has a thumb portion thereof that is integral with the body and selectively individually articulable therefrom with a thumb passage therein. The inner layer forms a substantially liquid-tight interior of the mitt such that a hand can selectively fit within the interior and the thumb of the hand fits within the thumb passage. The thumb portion preferably articulates away from the body with force applied by the thumb inserted into the thumb passage.

The present inventive hygienic mitt therefore provides an advantage in that it minimizes the risk of fecal matter-to-skin contact when wiping the anal region, while allowing the thumb to move about semi-freely for optimal cleaning. The mitt is also inexpensive to manufacture and store as an easily dispensable roll or stack, and is therefore an alternative to toilet paper. Furthermore, the present mitt represents a savings in paper and materials as less paper used to fully cover the hand as would otherwise be required by toilet paper to minimize fecal matter-to-skin contact. Also, the present mitt provides an excellent aid to children and others who make lack the dexterity or ability to adequately utilize toilet paper for cleaning.

The mitt can also have different embodiments, such as side folds to expand the interior of the mitt to fit larger hands. There also can be one or more external removable layers of paper that can be peeled from the mitt when soiled. Also, the external wiping layer can be “wet” and contain or be coated with moisturizer or other chemicals to assist in cleaning.

Other aspects, features, and advantages of the present invention will become apparent after review of the hereinafter set forth Brief Description of the Drawings, Detailed Description of the Invention, and the Claims.

### BRIEF DESCRIPTION OF THE DRAWINGS

FIG. 1A is a perspective view of one embodiment of the disposable mitt with a selectively detachable thumb portion, and the mitt is still removably attached to other mitts on a roll of disposable mitts.

FIG. 1B is a perspective view of the disposable mitt in FIG. 1A detached from the roll, and with a hand inserted into the mitt.

FIG. 1C is a perspective view of the disposable mitt in FIGS. 1A and 1B, with the thumb having separated the thumb portion from the body of the mitt.

FIG. 2 is a cross-section of the disposable mitt along Line A-A in FIG. 1A.

FIG. 3 is one example of a roll of the disposable mitts in removable attachment to each other.

FIG. 4 is a cross-section of a formed roll of the inner and outer layer that ultimately are pressed together to form the mitt.

FIG. 5A is a bottom perspective view of another embodiment of the disposable mitt with the thumb portion being a folded pouch to the body.

FIG. 5B is a bottom perspective view of the disposable mitt of FIG. 4B with a hand in the mitt and a thumb within the thumb portion folding out the thumb pouch.

FIG. 6 is a perspective view of another embodiment to create a series of detachable mitts with a plurality of rolls of materials being pressed together to form the mitts.

FIG. 7A is one embodiment of the series of mitts placed into a stacked arrangement.

FIG. 7B is one embodiment of a dispenser for mitts held therewithin in a stacked arrangement.

FIG. 8A is a perspective view of an alternate embodiment of the disposable mitt with a selectively extendable thumb portion.

FIG. 8B is a perspective view of the disposable mitt in FIG. 8A, with a hand inserted into the mitt.

FIG. 8C is a perspective view of the disposable mitt in FIGS. 1A and 1B, with the thumb having extended the thumb portion from the body of the mitt.

FIG. 8D is a side view of the disposable mitt in FIG. 8C showing the mitt opened up with the side folds pushed outward.

FIG. 9 is a cross-section of the alternate embodiment of the mitt in FIG. 8A, along line D-D thereof.

### DETAILED DESCRIPTION OF THE INVENTION

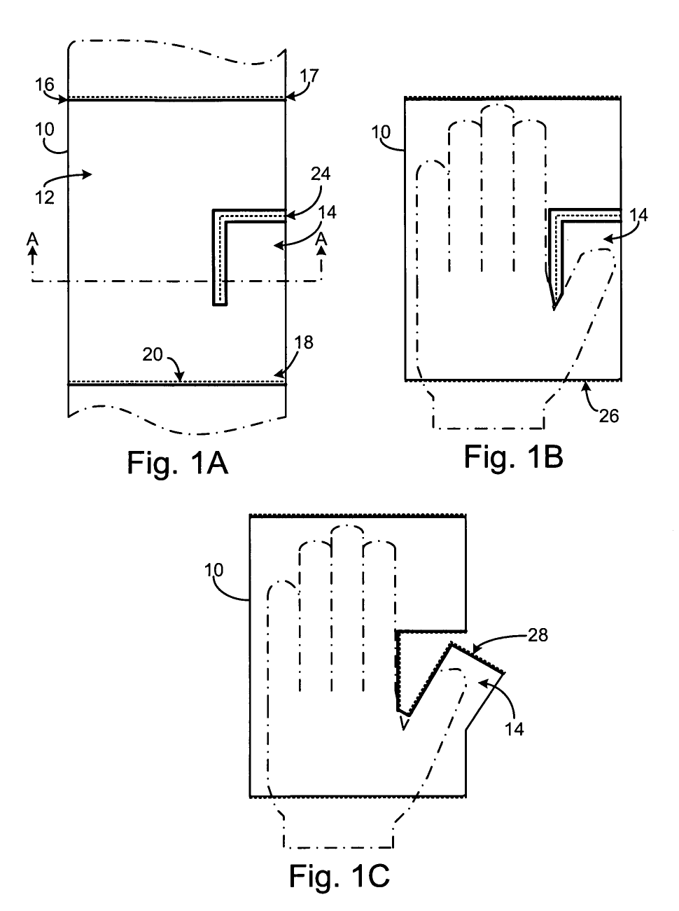

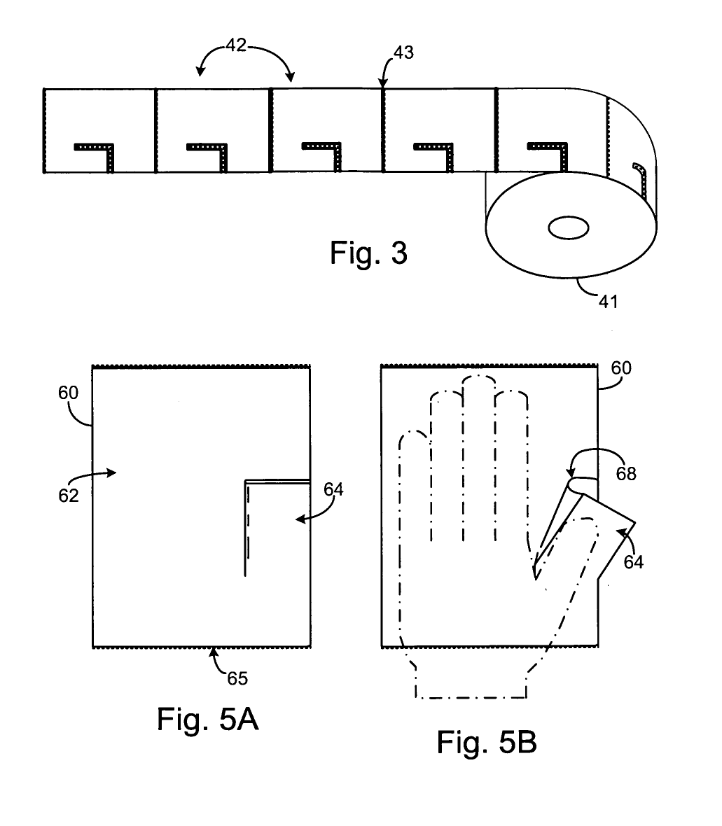

FIG. 1A is a perspective view of one embodiment of the disposable mitt 10 with a, a rectangular body 12, the body 12 including a thumb portion 14 thereof, the thumb portion 14 is integral with the body 12 and selectively individually articulable therefrom, which provides the dexterity for adequate cleaning of the anal region. The thumb portion 14 includes a thumb passage (50 in FIG. 4B) that allows the thumb to slide therein, as shown in FIG. 1B. The mitt 10 is shown here as in a detachable attachment in a roll (30 in FIG. 3) with a upper separation line at top edge 16 and lower separation line 20 at lower edge 18. The separation lines can be a perforated line, score line, or other line of predetermined cleavage as is know in the art. The individual mitts 10 separate such that the seal line 17 keeps the top of the mitt sealed and the lower score line 26 allows an opening into the interior passage of the mitt 10 such that a hand can fit within the interior of mitt 10, as shown in FIG. 1B, and as more fully described below.

In this embodiment, as shown in FIG. 1C, the hygienic mitt 10 includes a separation line 24 between the thumb portion 14 and body 12 such that the thumb can separate the thumb portion 14 such that the thumb portion becomes selectively articulable from the body 12. Separating the thumb portion 14 from the body along the separation line 24 still maintains a liquid-tight seal on the upper end 28 of the thumb portion 14, as well as the body 12.

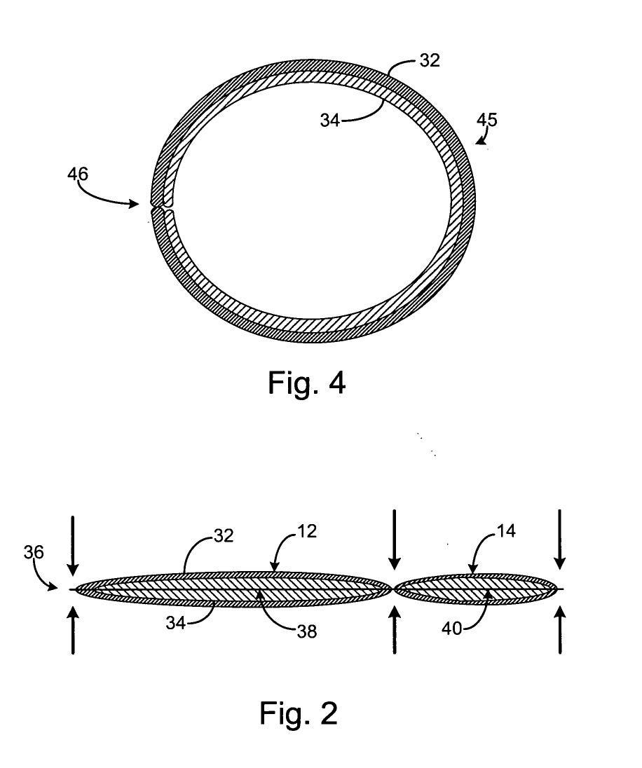

FIG. 2 is a cross-section of the disposable mitt along Line A-A in FIG. 1A. As shown, in each of the body 12 and thumb portion 14, the inner layer 34 forms a substantially liquid-tight interior of the mitt 10 with a body interior 38 and the thumb interior 40 where the hand and thumb fit. Thus, the interior of the body 12 and thumb portion 14 are accordingly selectively opened from detachment of another hygienic mitt from the bottom edge 20

Thus, as can be seen in FIG. 2, the mitt 10 is formed of at least an outer absorbent layer 32 and an inner substantially liquid-repellant layer 34. Multiple layers can also be used to form the outer layer 32 such that the layers can be peeled off from the mitt 10 as they are soiled. Moreover, the outer layer 32 can be moist with chemical and/or scent to assist in cleaning, similar to extant “wet wipes” and “baby wipes.” As known in the art, the outer layer 32 can contain such liquids as alcohol, mineral oils, skin cleansers, emollients, surfactants, propylene glycol, sodium lauryl sulfate, and other preferable non-irritants. Because of the inner layer 34 being liquid-repellant, any liquid contained in the outer layer 32 would not contact the skin of the hand when inserted into the mitt 10. Such embodiment therefore allows the use of a moist or wet wipe without having to get the hand of the user wet from the usage.

The outer absorbent layer 32 can be paper, plastic, cloth, fibrous, or other absorbent material that is adequate for cleaning fecal matter from skin. The inner substantially-liquid repellent layer 34 is preferably biodegradable plastic, either polymer or starch-based, but can be another liquid repellant material that can be flushed down a toilet and easily disposed of. There can also be a third layer (not shown) within the inner substantially liquid-repellant layer 34 such that a hand placed within the interior 38 of the body does not contact the inner substantially liquid-repellant layer 34, such as another layer of textured paper for a better tactile feel for the hand of the user.

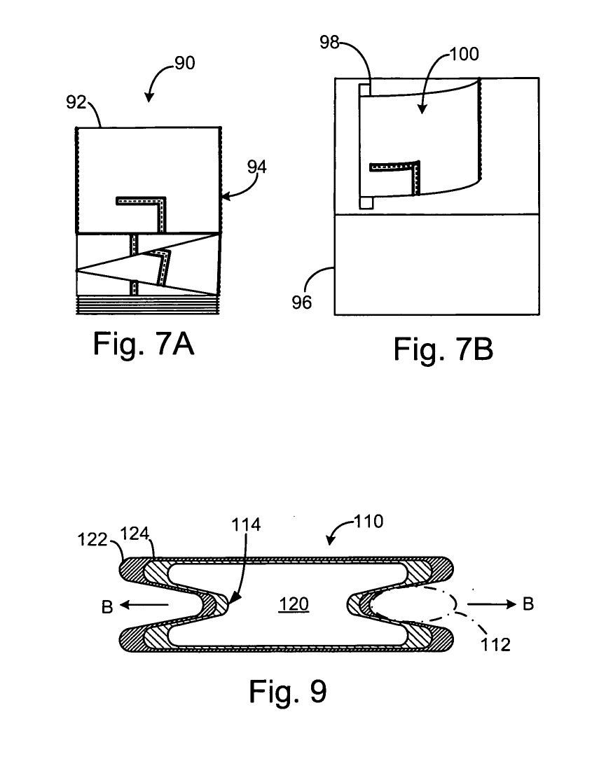

FIG. 3 is one example of a roll 41 of the disposable mitt 42 is removable attachment to each other, as shown at score line 43. Thus, in this embodiment, the mitt 10 can be stored and dispensed in the same manner as toilet paper. In such embodiment, the dimensions of the mitt 10 will be about 6 inches from top to bottom and 4 inches in width. Other sizes can be used for the mitt 10, such as smaller for children and larger for adults. While the preferred size here is for purposes of dispensation on a toilet paper roll, other dispensers, such as dispenser 96 in FIG. 7B, can easily handle mitts of any dimension.

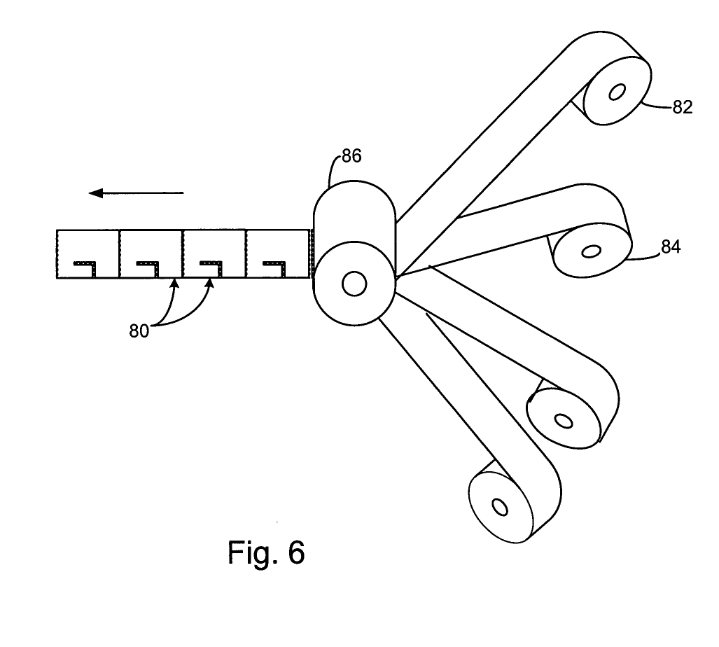

FIG. 4 is a cross-section of a formed roll 45 of the inner layer 34 and outer layer 32 that ultimately are pressed together to form the mitt 10, as shown in FIG. 2. The material for the layers is joined at a mutual outer edge, here seam 46, which ultimately becomes an outside edge of the formed mitt 10, shown as edge 36 in FIG. 2. While forming the mitt 10 in a pressed roll 45 is one method of manufacture, other methods of manufacture are likewise usable, such as simple pressing as shown in FIG. 6, as is further described below.

Thus, as shown in FIG. 4, the present invention provides a method of manufacturing a roll of individually connected, disposable hygienic mitts, such as through forming an inner tube of a substantially liquid-repellant layer 34; forming an outer tube of an absorbent layer 32 outside of the inner tube, then forming a roll (such as roll 41 in FIG. 3) of individually connected, disposable hygienic mitts 10 from the pressing together of the outer tube 32 and inner tube 34 such that each mitt 10 is in selective attachment to at least one other mitt 10 on the roll 41 and has a rectangular body formed of the outer absorbent layer 32 and inner substantially liquid-repellant layer 34.

FIG. 5A is a bottom perspective view of another embodiment of the disposable mitt 60 with the thumb portion 64 being a folded pouch to the body 62. In this embodiment, the thumb portion is in a folded, detachable relationship with the body 62 and is selectively articulable from the body 62 by placing the thumb in the thumb passage and folding out the thumb portion, as shown in FIG. 5B. The opening for the hand is at the lower edge 66 of the mitt 60, and the opening is preferably creating by detaching the mitt 60 from another mitt 60, in the same manner as the embodiment shown in FIGS. 1A-1C. FIG. 5B is a bottom perspective view of the disposable mitt 60 of FIG. 4B with a hand in the mitt 60 and a thumb within the thumb portion 64 folding out the thumb pouch, while still having a connected relation (web 68) to the body 62.

FIG. 6 is a perspective view of another embodiment to create a series of detachable mitts 80 with a plurality of rolls, such as the outer layer roll 82 and inner layer roll 84, of materials being pressed together to form the mitts 80. The layers of material are then pressed and sealed together, through glue, heat welding, or other methods of joining layers of material as is known in the art.

FIG. 7A is one embodiment of the series of mitts 90 placed into a stacked arrangement 92 with each mitt folded from the previous mitt along an edge, such as edge 94 Thus, as shown in FIG. 7B, the stacked arrangement 90 can be held with a dispenser 96. On top of the dispenser 96 is a slit 98 that allows the dispensation of a single mitt 100, with the mitt 100 being pulled through the slit 98 and torn from the previous mitt, which then remains in the slit 98 for dispensation.

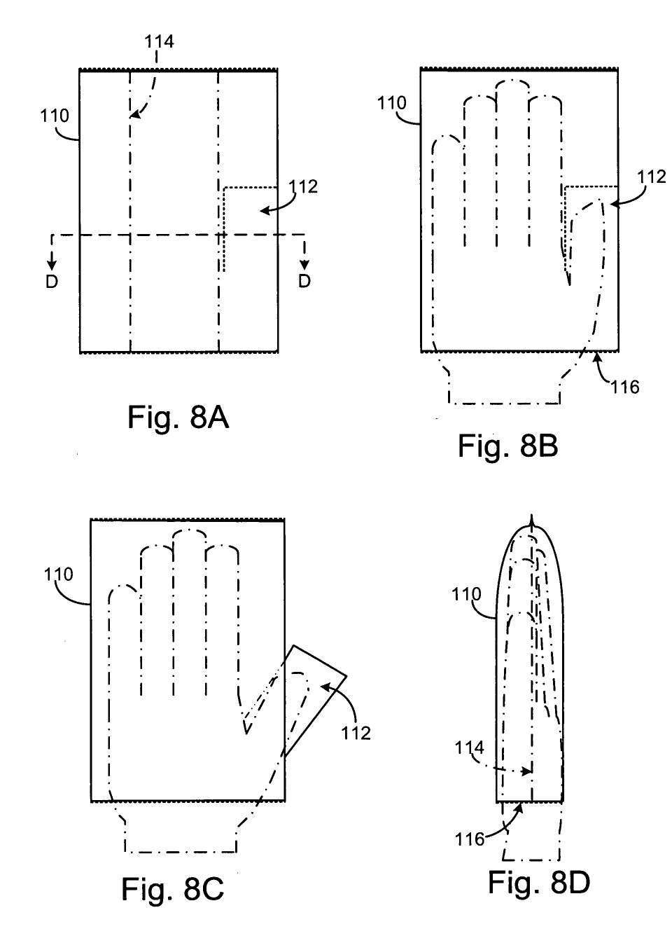

FIG. 8A is a perspective view of an alternate embodiment of the disposable mitt 110 with a selectively extendable thumb portion 112. There is an interior side fold 114, as is more clearly shown in FIG. 9. Thus, as shown in FIG. 8B a hand is inserted into the mitt 110, through the opening at the bottom 116 of the mitt 110, with the thumb being inserted into the thumb portion 112. Then, as shown in FIG. 8C, the thumb will extend the thumb portion 112 from the body of the mitt 110, as the mitt 100 is opened up. FIG. 8D is a side view of the disposable mitt in FIG. 8C showing the mitt opened up with the side folds 114 pushed outward.

FIG. 9 is a cross-section along line D-D of FIG. 8A of the alternate embodiment of the mitt 110 having inwardly folded side 114 to create a larger interior 120 of the mitt 110 for the hand to fit within. Here the outer layer 122 and inner layer 124 are folded internally and open outward, in the direction of Arrows B, to create a larger interior 120. The thumb portion 112 can be within or outside of the fold and be configured in the manner as described above.

While there has been shown a preferred and several other embodiments of the present invention, it is to be appreciated that certain changes can be made in manufacturing the mitt without departing from the underlying spirit and scope of the invention as set forth in the Claims.

What is claimed:

1. A disposable hygienic mitt, comprising:
a rectangular body formed of at least an outer absorbent layer and an inner substantially liquid-repellant layer, the body including a thumb portion thereof, the thumb portion integral with the body and selectively individually articulable therefrom and including a thumb passage therein, and the inner layer forming a substantially liquid-tight interior of the mitt such that a hand selectively fits within the interior and the thumb of the hand fits within the thumb passage.

2. The hygienic mitt of claim 1, including a separation line between the thumb portion and body such that the thumb is selectively articulable from the body by separating the thumb portion from the body along the separation line.

3. The hygienic mitt of claim 1, wherein the thumb portion is in a folded, detachable relationship with the body and is selectively articulable from the body by placing the thumb in the thumb passage and folding out the thumb portion.

4. The hygienic mitt of claim 1, further comprising a top edge and bottom edge, and wherein the hygienic mitt is attached to and removable from another hygienic mitt at each edge, and the interior of the body is selectively opened from detachment of another hygienic mitt from the bottom edge.

5. The hygienic mitt of claim 1, wherein the outer absorbent layer is paper and the inner substantially-liquid repellent layer is biodegradable plastic.

6. The hygienic mitt of claim 1, further comprising a third layer within the inner substantially liquid-repellant layer such that a hand placed within the interior of the body does not contact the inner substantially liquid-repellant layer.

7. The hygienic mitt of claim 6, wherein the third layer is paper.

8. The hygienic mitt of claim 1, wherein the outer absorbent layer includes a liquid therewithin.

9. A roll of individually connected, disposable hygienic mitts, each mitt having a rectangular body formed of at least an outer absorbent layer and an inner substantially liquid-repellant layer, the body including a thumb portion thereof, the thumb portion integral with the body and selectively individually articulable therefrom and including a thumb passage therein, and the inner layer forming a substantially liquid-tight interior of the mitt such that a hand selectively fits within the interior and the thumb of the hand fits within the thumb passage, and each mitt in selective attachment to at least one other mitt on the roll.

10. The roll of claim 9, wherein each mitt includes a top edge and bottom edge, and wherein each hygienic mitt is attached to and removable from at least another hygienic mitt at least one of the top edge and bottom edge.

11. The roll of claim 9, wherein the roll is formed from a outer tube of an absorbent layer and an inner tube of a substantially liquid-repellant layer fitted within the outer tube.

12. The roll of claim 11, wherein the outer tube of an absorbent layer is paper and the inner tube of a substantially-liquid repellent layer is biodegradable plastic.

13. The roll of claim 11, further comprising a third tube layer fitted within the inner tube of a substantially liquid-repellant layer such that each mitt includes a third layer within the inner substantially liquid-repellant layer wherein a hand placed within the interior of the body does not contact the inner substantially liquid-repellant layer.

14. A method of manufacturing a roll of individually connected, disposable hygienic mitts, comprising:
forming an inner tube of a substantially liquid-repellant layer;
forming an outer tube of an absorbent layer outside of the inner tube;
forming a roll of individually connected, disposable hygienic mitts from the pressing together of the outer tube and inner tube such that each mitt has a rectangular body formed of the outer absorbent layer and inner substantially liquid-repellant layer and includes a thumb portion thereof, the thumb portion integral with the body and selectively individually articulable therefrom and including a thumb passage therein, and the inner layer forming a substantially liquid-tight interior of the mitt such that a hand selectively fits within the interior and the thumb of the hand fits within the thumb passage, and each mitt in selective attachment to at least one other mitt on the roll.

15. The method of claim 14, further comprising forming a separation line between the thumb portion and body of the mitt such that the thumb is selectively articulable from the body by separating the thumb portion from the body along the separation line.

16. The method of claim 14, further comprising forming the thumb portion in a folded, detachable relationship with the body such that the thumb portion is selectively articulable from the body by placing the thumb in the thumb passage and folding out the thumb portion.

17. The method of claim 14, wherein forming each mitt is making a top edge and bottom edge of each mitt with a separation line next to the top edge and bottom edge such that each mitt is attached to and removable from another mitt at each edge, and the interior of the body is selectively opened from detachment of another mitt from the bottom edge.

18. The method of claim 14, further comprising forming a third tube within the inner tube of substantially liquid-repellant layer such that a third layer is created within the interior of each formed mitt.
